(19) United States
(12) Patent Application Publication
(10) Pub. No.: US 2023/0254714 A1
(43) Pub. Date: Aug. 10, 2023

(54) LOCAL WIRELESS COMMUNICATION SYSTEM, IN-AREA RECEPTION QUALITY CONTROL METHOD, CONTROLLER, AND PROGRAM

(71) Applicant: NIPPON TELEGRAPH AND TELEPHONE CORPORATION, Tokyo (JP)

(72) Inventors: Daisuke MURAYAMA, Musashino-shi, Tokyo (JP); Shota NAKAYAMA, Musashino-shi, Tokyo (JP); Kenichi KAWAMURA, Musashino-shi, Tokyo (JP)

(73) Assignee: NIPPON TELEGRAPH AND TELEPHONE CORPORATION, Tokyo (JP)

(21) Appl. No.: 18/010,341

(22) PCT Filed: Jun. 16, 2020
(86) PCT No.: PCT/JP2020/023631

§ 371 Date: Dec. 14, 2022

(51) Int. Cl. H04W 24/06; H04W 24/10

(52) U.S. Cl. CPC H04W 24/06; H04W 24/10

(57) ABSTRACT

The present disclosure is a local wireless communication system for forming a wireless communication environment on a predetermined band. This system includes a base station that emits a radio wave to form the wireless communication environment in a predetermined area, a plurality of sensors disposed in the area, and a controller that controls a transmission state of the radio wave from the base station. Each of the plurality sensors measures a reception quality of the measurement signal transmitted from the base station and feeds back the reception quality to the controller via the base station. The controller evaluates the reception quality fed back and determines a parameter to be given to the base station in accordance with an evaluation result. The base station transmits the measurement signal in accordance with a parameter given from the controller.

### TECHNICAL FIELD

The present disclosure relates to a local wireless communication system, set up for example, on a self-operated basis, an in-area reception quality control method, a controller, and a program used in such a system.

### BACKGROUND ART

The fifth-generation mobile communication system (5G) has features, such as ultra-high speed, ultra-low latency, and multiple simultaneous connections and is expected to be a next-generation mobile communication system. The 5G utilizes various frequency bands from relatively low bands such as 800 MHz, 2 GHz, sub-6 GHz bands, or Wi-Fi (trade name) to high frequency bands such as a millimeter wave band. Available bands are licensed by a public agency.

A local 5G (L5G) that is currently studied can be said to be a local wireless communication system using the 5G technology. The L5G is a self-operated wireless communication system by various entities, such as companies or local governments, having licenses other than telecommunications operators and is provided in a limited area, such as on premises or in buildings.

One of concerns for the local wireless communication system represented by the L5G is a dead zone that can be generated in the area in relation to a shield object. Forming an area by using, in particular, high frequency bands (6 GHz or more, for example, 28 GHz band) more likely degrade the reception quality locally due to the shield object, because radio waves have high rectilinear propagation. The generation of the dead zone having poor reception quality in the area should be avoided as much as possible. The method for measuring the reception quality is disclosed in, for example, NPL 1.

### CITATION LIST

### Non Patent Literature

NPL 1: “Status of Investigations on Physical-layer Elemental Technologies and High-frequency-band Utilization in 5G”, NTT DoCoMo Technical Journal Vol. 25, No. 3 (Octpber 2017)

### SUMMARY OF THE INVENTION

### Technical Problem

The present disclosure has been made in view of the above circumstances and intends to provide a technique capable of improving the reception quality in an area.

### Means for Solving the Problem

A local wireless communication system according to the present disclosure forms a wireless communication environment on a predetermined band. This system includes a base station that emits a radio wave to form the wireless communication environment in a predetermined area, a plurality of sensors disposed in the area, and a controller that controls a transmission state of the radio wave from the base station. Each of the plurality of sensors is configured to perform processing of receiving a measurement signal transmitted from the base station, processing of measuring a reception quality of the measurement signal received, and processing of feeding back the reception quality to the controller either via the base station or in a direct manner. The controller is configured to perform processing of evaluating the reception quality fed back from each of the plurality of sensors and determining a parameter to be given to the base station in accordance with an evaluation result and processing of giving the parameter determined to the base station. The base station is configured to perform processing of generating a measurement signal and processing of transmitting the measurement signal in accordance with the parameter given from the controller.

### Effects of the Invention

The present disclosure allows for providing a technique enabling the reception quality to be improved by maximally eliminating dead zones in an area.

### BRIEF DESCRIPTION OF DRAWINGS

FIG. 1 is a diagram for describing an overview of a local wireless communication system.

FIG. 2 is a diagram for describing a multibeam control method that is being studied for use in L5G.

FIG. 3 is a system diagram illustrating an overall configuration of the local wireless communication system according to a first embodiment of the present disclosure.

FIG. 4 is a functional block diagram of the local wireless communication system according to the first embodiment of the present disclosure.

FIG. 5 is a flowchart illustrating a processing procedure of a sensor according to the first embodiment of the present disclosure.

FIG. 6 is a flowchart illustrating a processing procedure of a base station and a controller according to the first embodiment of the present disclosure.

FIG. 7 is a system diagram illustrating an overall configuration of a local wireless communication system according to a second embodiment of the present disclosure.

### DESCRIPTION OF EMBODIMENTS

Hereinafter, embodiments of the present disclosure will be described with reference to the drawings.

### 1. First Embodiment

### 1-1. Overview

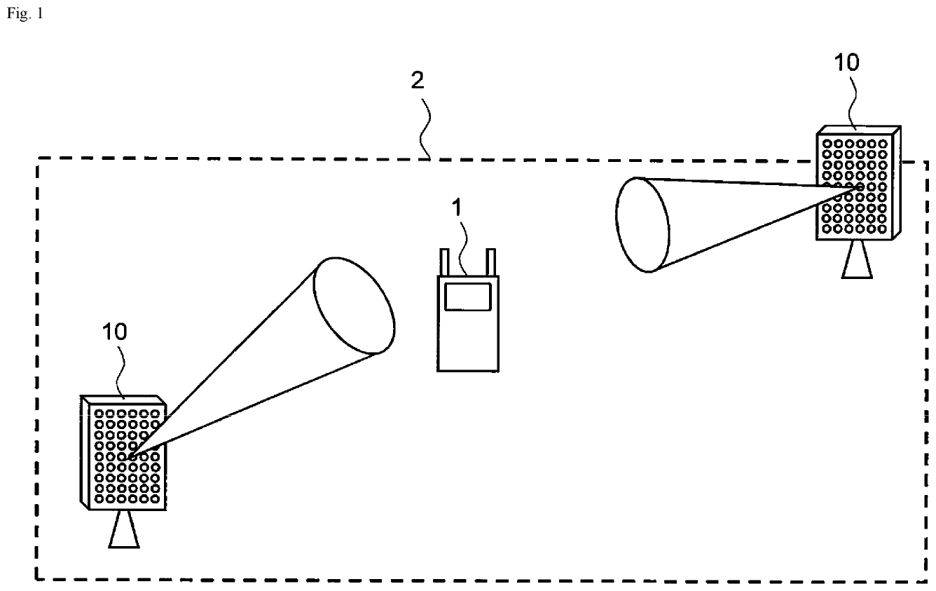

FIG. 1 is a diagram for describing an overview of a local wireless communication system, in particular, L5G, which is a precondition of the present disclosure. L5G is a system for providing a communication service using 5G in a limited service area 2. L5G provides one or more base stations 10 for emitting radio waves on a licensed band. Beams of the radio waves emitted from the base station 10 form a wireless communication environment in the service area 2. In FIG. 1, although the base stations 10 are disposed in the service area 2, in some cases, the base stations 10 are disposed outside the service area. In some cases, the beams of the radio waves are emitted from the base station 10 disposed apart from the service area 2 across other owner's land.

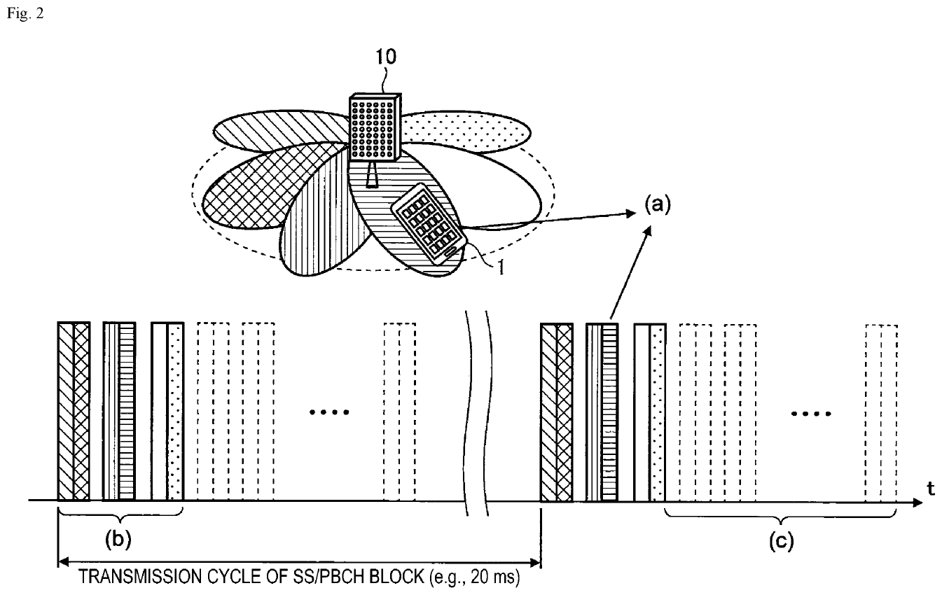

The base station 10 for L5G uses a multibeam antenna. FIG. 2 is a diagram for describing a multibeam control method that is being studied for use in L5G. Details are disclosed in NPL 1, and its outline will be described here.

In standardized 5G new radio (NR), the base station 10 transmits an SS/PBCH block of each beam temporally, exclusively, and periodically. The SS/PBCH block of each beam transmitted from the base station 10 is basically transmitted at identical transmission power. Each beam is associated with its transmission time slot by the same hatching in FIG. 2.

(a) A wireless terminal 1 in the service area 2 detects a frame slot timing from an identifier of the SS/PBCH block. When detecting a beam having a good reception quality, the wireless terminal 1 transmits a random access signal (PRACH) by using a resource corresponding to the beam. In a 3GPP (trade name)-standardized random access procedure or the like, the wireless terminal 1 determines as small transmission power as possible capable of reaching the base station 10 while gradually increasing the power.

(b) The transmission cycle of the SS/PBCH block can be selected from 5, 10, 20, 40, 80, or 160 milliseconds (ms). The SS/PBCH block is associated with each beam, and thus the number of a plurality of SS/PBCH blocks corresponds to the number of beams. (c) A candidate resource of an unused SS/PBCH block can be used for data communication and the like.

The service using L5G needs to achieve good communication between the base station 10 and the wireless terminal 1 whenever the wireless terminal 1 is located in the service area 2. Unfortunately, the presence of various shield objects practically makes it difficult to achieve the best communication state at all locations in the service area 2. The local wireless communication system according to the first embodiment of the present disclosure to be described below is a system capable of maximally eliminating the dead zones in the service area 2 and improving the reception quality in the service area 2.

1-2. Overall System Configuration

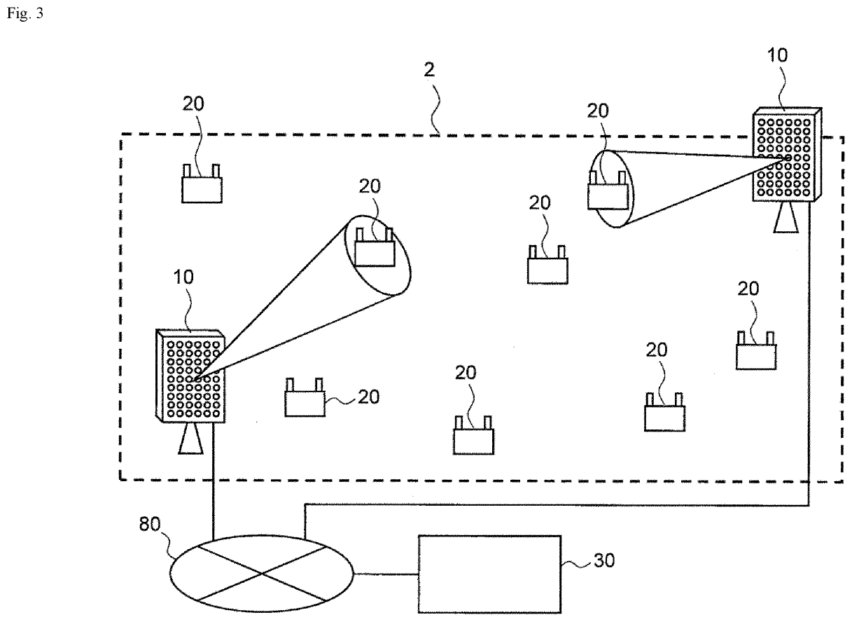

FIG. 3 is a system diagram illustrating an overall configuration of the local wireless communication system according to the first embodiment of the present disclosure. This system includes one or more base stations 10, a plurality of sensors 20, and a controller 30. The base station 10 has a multibeam antenna and emits radio waves of multibeam in the service area 2 to form a wireless communication environment. Here, it is assumed that the plurality of base stations 10 are disposed as illustrated in FIG. 3. The disposition location of the base station 10 is inside the service area 2 in FIG. 3 but may be outside the service area 2 as described above.

Each of the plurality of sensors 20 is disposed in the service area 2. Each sensor 20 is fixedly disposed at a predetermined location but is movable. The sensor 20 is capable of communicating with any of the base stations 10. The sensor 20 captures any of the beams emitted from the base station 10 and acquires a wireless communication channel through a predetermined sequence. The base station 10 that has received a channel connection request from the sensor 20 establishes a communication link with the sensor 20.

The base station 10 is communicably connected to the controller 30 via a network 80. This means that the sensor 20 is indirectly and communicably connected with the controller 30 via the base station 10. The network 80 is preferably a wired network such as a local area network (LAN) to prevent unnecessary radio wave leakage.

1-3. System Functionality

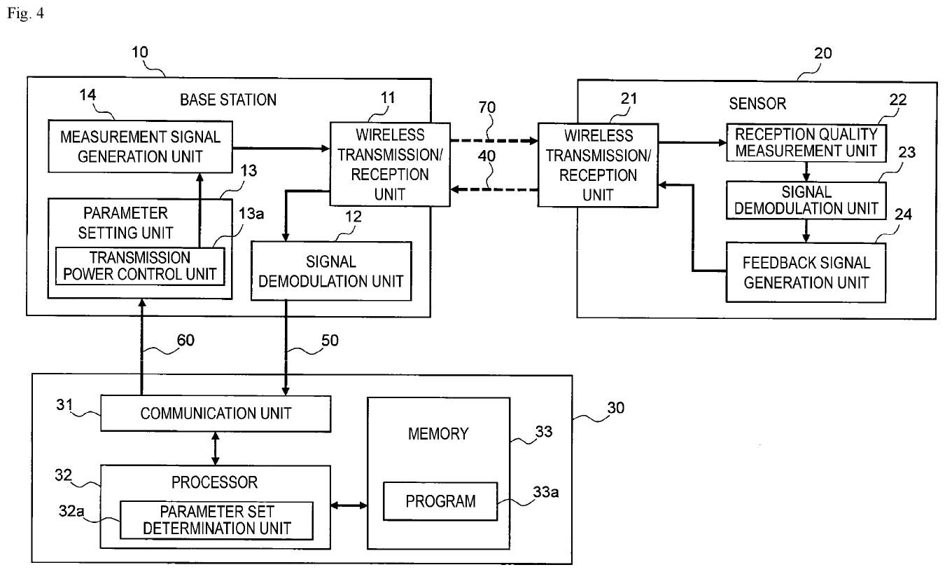

FIG. 4 is a functional block diagram of the local wireless communication system according to the first embodiment of the present disclosure. FIG. 4 illustrates respective functions of the base station 10, the sensor 20, and the controller 30, and signal flows between the apparatuses and in each apparatus. FIG. 4 is a block diagram illustrating an example of functions necessary when the sensor 20 is wirelessly connected with the base station 10 and is connected with the controller 30 via the base station 10.

The sensor 20 includes a wireless transmission/reception unit 21, a reception quality measurement unit 22, a signal demodulation unit 23, and a feedback signal generation unit 24. These functional units may be configured with a circuit constituting the sensor 20 or may be configured with a circuit and software.

The wireless transmission/reception unit 21 communicates with the base station 10 via a wireless channel. The wireless transmission/reception unit 21 as a reception unit receives a measurement signal 70 transmitted with multibeam from each base station 10. As the measurement signal 70, for example, an SS/PBCH block is used. In addition, the wireless transmission/reception unit 21 as a transmission unit transmits a feedback signal 40 to the base station 10 by using a user data region of a channel allocated from the base station 10 or a control message. A method for selecting the base station 10, which is a connection destination of the sensor 20, and a method for selecting the beam can use, for example, a sequence compliant to the 3GPP (trade name) standard.

The reception quality measurement unit 22 measures the reception quality of the measurement signal 70 transmitted from the base station 10 for each base station 10 and for each beam of the multibeam. The reception quality to be measured is any one of SS-RSRP, CSI-RSRP, NR-RSSI, CSI-RSSI, SS-RSRQ, CSI-RSRQ, SS-SINR, and CSI-SINR, or a combination of a plurality of them.

The signal demodulation unit 23 demodulates the measurement signal 70 and decodes information included in the measurement signal 70. The measurement signal 70 includes, a base station identifier, which is an identifier of the base station 10 that emits the measurement signal 70, and a beam identifier, which is an identifier of the beam on which the measurement signal 70 is emitted.

The feedback signal generation unit 24 generates a feedback signal including the reception quality measured by the reception quality measurement unit 22. The feedback signal includes, in detail, the base station identifier and the beam identifier, in addition to the reception quality. The wireless transmission/reception unit 21 as the transmission unit transmits the feedback signal 40 to the base station 10 identified by the base station identifier.

The base station 10 includes a wireless transmission/reception unit 11, a signal demodulation unit 12, a parameter setting unit 13, and a measurement signal generation unit 14. These functional units may be configured with a circuit constituting the base station 10 or may be configured with a circuit and software.

The wireless transmission/reception unit 11 forms multibeam having a different direction in a time-division manner and transmits the measurement signal 70 for each beam. The wireless transmission/reception unit 11 transmits the measurement signal 70 by using parameters set by the parameter setting unit 13. The parameter in the present description is a parameter for a control target in relation to the transmission state of the radio wave. The specific control target includes transmission power, a used beam, a tilt/pan angle (when movable), a position (when movable), and an enable element of a distributed antenna. The parameters of a plurality of control targets among them are combined together and are used as a parameter set. However, regarding the parameter of the used beam, it can be used as a single parameter. In addition, the wireless transmission/reception unit 11 receives the feedback signal 40 transmitted from each sensor 20.

The signal demodulation unit 12 demodulates the feedback signal 40 from each sensor 20 and decodes information placed in the feedback signal 40. The feedback signal 40 from each sensor 20 includes a base station identifier for identifying from which base station 10 the signal has been transmitted and a beam identifier for identifying in which beam the signal has been transmitted in addition to the reception quality of the signal from the base station 10 measured by each sensor 20. The signal demodulation unit 12 notifies the controller 30 of decoded information including the reception quality measured by each sensor 20 as a feedback signal 50.

The parameter setting unit 13 sets the above-described parameters in accordance with a parameter set 60 given from the controller 30. The parameter setting unit 13 includes a transmission power control unit 13a. As illustrated in the above-described example of the control target, the transmission power is one of the control targets in relation to the transmission state of the radio waves. The transmission power control unit 13a controls the transmission power of the signal transmitted from the wireless transmission/reception unit 11 for each beam in accordance with the parameter (transmission power value) given from the controller 30.

The measurement signal generation unit 14 generates the measurement signal 70 to be transmitted from the wireless transmission/reception unit 11. The measurement signal 70 includes the base station identifier of the base station 10 and the beam identifier of each beam in the multibeam. The measurement signal 70 is repeatedly emitted from the base station 10 at the time of system activation, reset, or the like and is received by the sensor 20.

The controller 30 is, for example, a personal computer or a server computer. The controller 30 includes a communication unit 31 that communicates with the base station 10, a processor 32, and a memory 33.

The memory 33 is, for example, a random access memory (RAM) and stores a program 33a for achieving functions of the controller 30 according to the present embodiment. A program 33a is loaded from a storage medium such as a hard disk drive (HDD) or a solid state drive (SSD) to a storage area of the memory 33. A program such as an operating system (OS) or a device driver is also stored in the storage medium. Note that the storage medium may be constituted by combining the HDD or the SSD with a read only memory (ROM).

The processor 32 includes a parameter set determination unit 32a as a processing function according to the present embodiment. The parameter set determination unit 32a is implemented by the processor 32 executing the program 33a stored in the memory 33. That is, the controller 30 according to the present embodiment is achievable with a computer and a program. The program can be provided through a network, in addition to being recorded in a recording medium.

The parameter set determination unit 32a acquires the feedback signal 50 from the base station 10 via the communication unit 31. The feedback signal 50 includes the reception quality of the measurement signal 70 for each base station 10 for each beam, acquired from all the sensors 20 in the service area 2. The parameter set determination unit 32a statistically evaluates the reception quality included in the feedback signal 50 and determines a parameter set given to the base station 10 in accordance with an evaluation result. The parameter set determination unit 32a transmits the parameter set 60 determined to the parameter setting unit 13 of the base station 10 via the communication unit 31.

1-4. Method for Evaluating Reception Quality and Determining Parameter Set

Here, a description will be given with regard to a method for evaluating, by the parameter set determination unit 32a, the reception quality and a method for determining the parameter set in accordance with such an evaluation result. One example of the method for evaluating the reception quality is a method for evaluating by using the lowest value of an index value of the reception quality. The index value of the reception quality means a value such as SS-RSRP or CSI-RSRP described above. For evaluation, the lowest target value is predetermined. The lowest target value is, for example, an index value allowed for the lowest reception quality among all combinations of the base station identifiers and the beam identifiers, the reception qualities of which have been measured.

The index value of the lowest reception quality among the reception qualities included in the feedback signal 50 is set as the lowest value Q_P, and the lowest target value is set as Q_T. In a case where Q_T-Q_P>0, the reception quality of the service area 2 does not satisfy the lowest quality. In this case, the parameter set is changed by the parameter set determination unit 32a. A plurality of parameter sets are prepared beforehand. The parameter set is changed in a predetermined order from the default parameter, which is an initial value, until the lowest target quality is achieved. Then, in a case where Q_T-Q_P<0, it is determined that the lowest target quality has been achieved, and the parameter set is maintained at the current value. According to this method, it becomes possible to maintain the reception quality in the service area 2 to be equal to or higher than an allowable minimum quality.

Instead of the method for evaluating with use of the lowest value of the index value of the reception quality, a method for evaluating by using a total value of the index values of the reception quality is also applicable. Additionally, a method for evaluating by using an average value of the index value of the reception quality is also applicable. In the case of the former method, when the total value of the index values of the reception quality measured by the respective sensors 20 in the service area 2 is lower than a target total value, the parameter set is changed. In the case of the latter method, when the average value of the index values of the reception quality measured by the respective sensors 20 in the service area 2 is lower than a target average value, the parameter set is changed. These methods enable an improvement in the reception quality in the service area 2 as a whole.

The method for evaluating the reception quality described above is an example, and any other statistical technique may be combined to evaluate the reception quality. In addition, as a method for determining the parameter set, a parameter set or its candidate that further improves the reception quality by machine learning may be selected. There is no limitation on a method of the machine learning.

Note that in the above description, all the reception qualities measured by the respective sensors 20 in the service area 2 are included in the feedback signals 50 and are transmitted to the controller 30. However, the lowest value, the total value, or the average value of the index value of the reception quality based on the reception quality measured by the respective sensors 20 may be calculated beforehand, and only its statistic may be included in the feedback signals 50 to be transmitted to the controller 30. Instead of all of the reception qualities measured by all the respective sensors 20, by using only the statistic as the information included in the feedback signal 50, it becomes possible to reduce the communication amount from the base station 10 to the controller 30. The statistic of the index value of the reception quality may be calculated by the signal demodulation unit 12, or a statistic calculation unit may be provided on a subsequent stage for the calculation.

1-5. Processing Procedures of Sensor, Base Station and Controller

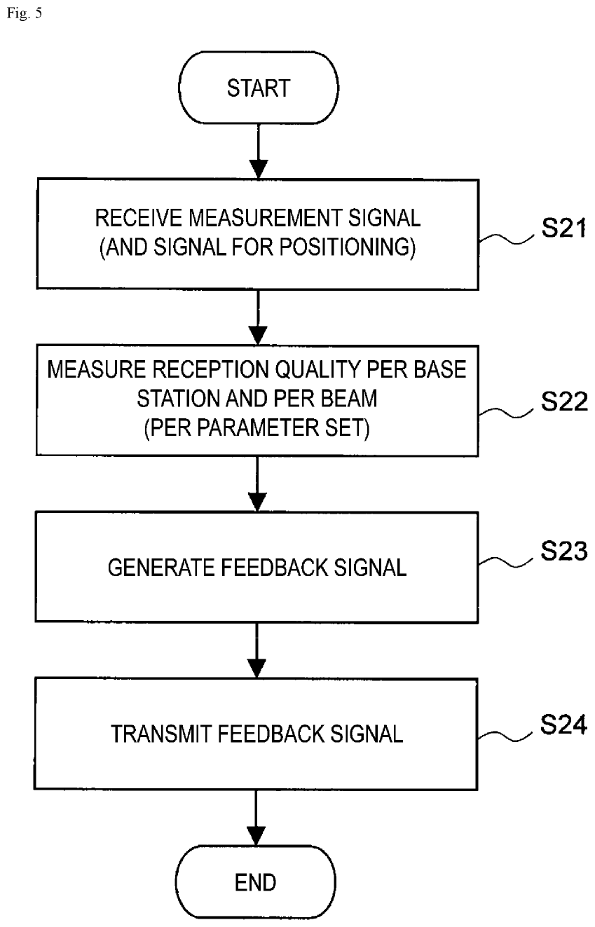

FIG. 5 is a flowchart illustrating an example of a processing procedure of the sensor 20. The sensor 20 receives the measurement signal 70 transmitted from the base station 10 (step S21). At this time, the sensor 20 may receive a positioning signal such as a global positioning system (GPS) signal. The position in the service area 2 can be measured by positioning with the GPS signal.

Next, the sensor 20 measures the reception quality of the measurement signal 70 received for each base station 10 and for each beam (step S22). Then, the sensor 20 generates a feedback signal including the reception quality measured for each base station 10 and for each beam (step S23). The sensor 20 transmits the feedback signal 40 generated to the base station 10 (step S24).

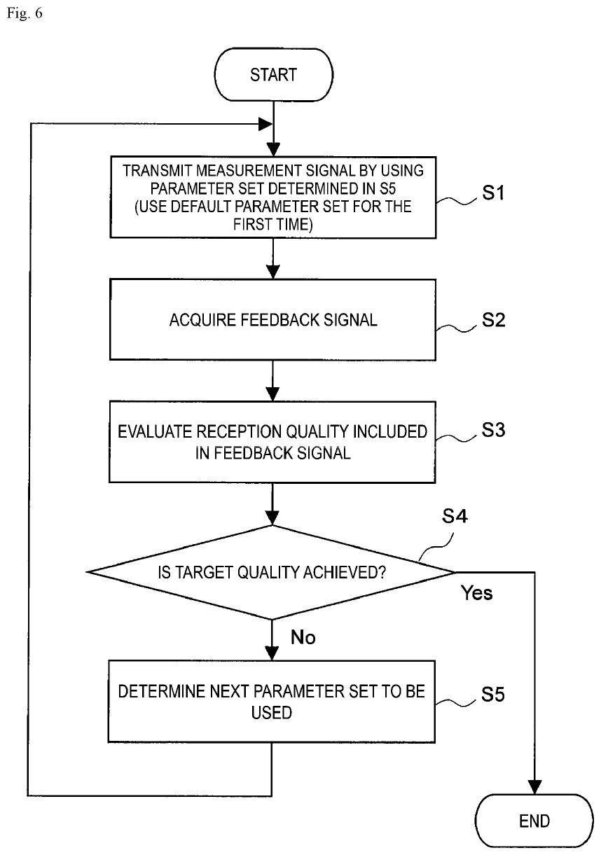

FIG. 6 is a flowchart illustrating an example of a processing procedure of the base station 10 and the controller 30. The processing procedure illustrated in this flowchart is performed at the time of, for example, initial startup of the system. Through this procedure, the parameter sets of the base stations 10 in the operation phase are individually determined.

The base station 10 transmits the measurement signal 70 with the parameter set given from the controller 30, that is, the parameter set determined in step S5 to be described later (step Si). However, when the present processing procedure is performed for the first time, a default parameter set is used. Next, the base station 10 acquires the feedback signals 40 from all the sensors 20 in the service area 2, and the controller 30 acquires the feedback signals 50 via the base station 10 (step S2).

The controller 30 evaluates the reception quality of the measurement signal 70 for each base station and for each beam included in the feedback signal 50 (step S3). For this evaluation, the statistic of the reception quality, such as the lowest value, the total value, the average valueas described above, is calculated. The controller 30 determines whether the reception quality in the service area 2 achieves the target quality in accordance with whether the statistic of the reception quality is equal to or more than the target value (step S4).

In a case where the determination result of step S4 is negative, that is, in a case where the reception quality does not achieve the target quality, the controller 30 determines the parameter set to be used next (step S5).

Repeating steps S1 to S5 causes a parameter set with the reception quality that achieves the target quality in the service area 2 to be found. In such a case, the determination result in step S4 becomes positive, and thus the present processing procedure ends while maintaining the parameter set determined in the previous step S5. The controller 30 performs such processing for each base station 10 and determines a parameter set capable of improving the reception quality in the service area 2 for each base station 10.

1-6. Effects

In the present embodiment as described above in detail, the plurality of sensors 20 are disposed in the service area 2 in the local wireless communication system such as L5G. Each sensor 20 measures the measurement signal transmitted from the base station 10 and notifies the controller 30 of a measurement result of the reception quality of the measurement signal via the base station 10. The controller 30 evaluates the reception quality of the measurement signal notified from the sensor 20 and determines a parameter set given to the base station 10 in accordance with the evaluation result to control the transmission state of the radio waves of the base station 10. Consequently, according to the present embodiment, it becomes possible to maximally eliminate the dead zones and improve the reception quality in the service area 2.

### 2. Second Embodiment

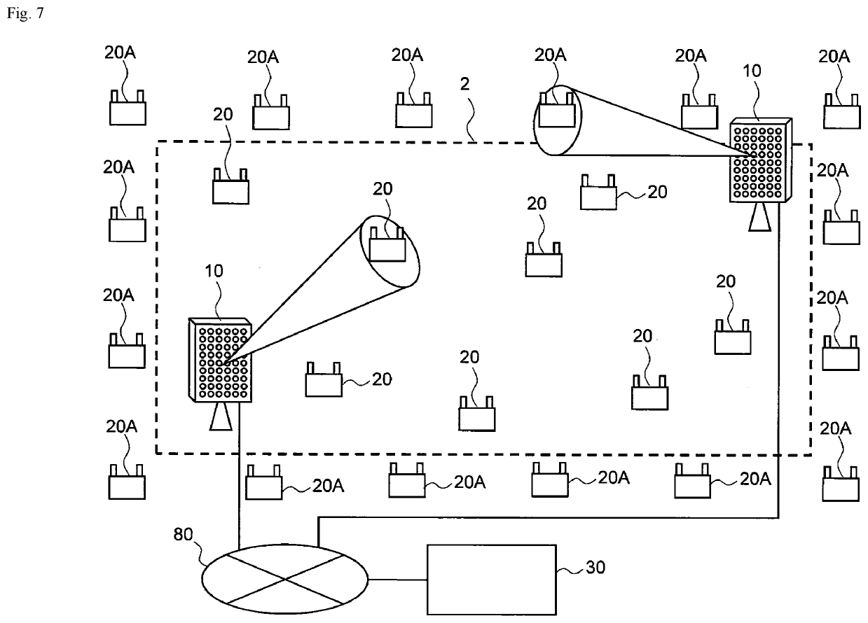

FIG. 7 is a system diagram illustrating an overall configuration of a local wireless communication system according to a second embodiment of the present disclosure. In FIG. 7, elements identical to those of the first embodiment are denoted by the same reference numerals. In the following description, descriptions of contents common to those in the first embodiment will be omitted, and descriptions will be given with regard to configurations and functions unique to the present embodiment.

In a local wireless communication system represented by the L5G, it is necessary to prevent radio wave interference between systems. For this purpose, it is necessary to minimize leakage radio waves to the outside of the service area 2. The second embodiment is a proposal of a system capable of reducing the leakage radio waves to the outside of the service area 2, while improving the reception quality in the service area 2.

In the present embodiment, in addition to the sensors 20 disposed in the service area 2, a plurality of sensors 20A are disposed along edges of the service area 2. Hereinafter, these sensors 20A are each referred to as an area edge sensor to be distinguished from the sensor 20 in the service area 2. A specific disposed position of the area edge sensor 20A may be on an edge of the service area 2, outside the edge, or inside the edge. The area edge sensor 20A receives the measurement signal transmitted from the base station 10. The measurement signal is received for each base station 10 and for each beam. The area edge sensor 20A measures reception power of the measurement signal received for each base station 10 and for each beam.

In the present embodiment, the base station 10 transmits the measurement signal in accordance with the transmission power for each beam given by the controller 30. However, a preset default value is used for the initial transmission power. The controller 30 calculates transmission power for the next transmission for each beam in accordance with various types of information including the reception power fed back from each sensor 20.

Next, the controller 30 compares the value of the transmission power calculated in the previous processing with the latest value of the transmission power calculated this time. In a case where the difference between them is equal to or smaller than a threshold, the controller 30 determines that the transmission power has converged on a constant value and ends the processing. On the other hand, in a case where the difference between the previous value and the latest value is larger than the threshold, the controller 30 causes the base station 10 to transmit the measurement signal with the latest transmission power calculated this time. In addition, the parameter set calculated in the first embodiment is used for transmitting the measurement signal from the base station 10.

The above processing is repeated several times, and thus the transmission power becomes a different value for each beam and converges to a constant value. Then, the reception power measured by the area edge sensor 20A converges to a value equal to or smaller than a predetermined threshold. Consequently, it becomes possible to achieve both an improvement in the reception quality in the service area 2 and a reduction in the leakage radio waves to the outside of the service area 2. Note that the transmission power is one of the control targets in relation to the transmission state of the radio wave, and its value is also a parameter for controlling the reception quality. Therefore, in a case where the transmission power is included in the parameter set, weighting may be conducted between the reception quality control and the area edge power control to determine the transmission power.

### 3. Third Embodiment

Next, a third embodiment of the present disclosure will be described. In the present embodiment, the wireless terminal 1 (see FIG. 1) capable of transmitting and receiving signals to and from the base station 10 (see FIG. 1) is used as a sensor disposed in the service area 2 (see FIG. 1). In the present embodiment, the base station 10 transmits an SS/PBCH block with different parameter sets by using a standardly specified resource as an SS/PBCH block having a pseudo-different beam.

The wireless terminal 1 disposed in the service area receives an SS/PBCH block with a different parameter set transmitted from the base station 10 and measures its reception quality. The measurement is conducted as an SS/PBCH block subject to beam sweeping in accordance with the standard such as 3GPP Rel-15. The wireless terminal 1 performs an initial access operation to the base station by using the SS/PBCH block having the best reception quality among the SS/PBCH blocks received. The initial access operation corresponds to processing of feeding back the reception quality to the base station 10. In a case where the initial access operation is performed by the wireless terminal 1, the controller 30 (see FIG. 3) that controls the base station 10 sets, for the base station 10, a parameter set corresponding to the SS/PBCH block used for the initial access operation.

According to the present embodiment, it is possible to determine the parameter set for the base station 10 capable of improving the reception quality in the service area 2 without especially modifying the wireless terminal 1.

### 4. Other Embodiments

(1) In the above-described embodiments, it is assumed that the controller 30 is disposed in the vicinity of the base station 10 through a LAN or the like. Instead of this, the public network may be utilized as the network 80 and the controller 30 may be disposed remotely from the base station 10.

(2) In the above-described embodiments, a description has been given that the wired network 80 is preferably used. Instead of this, the base station 10 and the controller 30 may be wirelessly connected with each other by IAB, WiGig, or the like. In a case where the sensor 20 has a communication function like a wireless terminal, the sensor 20 and the base station 10 or the sensor 20 and the controller 30 may be wirelessly connected with each other.

(3) In the above-described embodiments, a description has been given that the feedback signal 40 is transmitted from the sensor 20 to the base station 10 through a radio resource of the base station 10. Instead of this, the sensor 20 may be wired to the base station 10 so that the base station 10 is notified of the feedback signal over a wired line. In this way, consumption of radio resources can be reduced, and thus it is possible to increase the number of wireless terminals 1 capable of being housed.

(4) In the above-described embodiments, a personal computer or a server computer is assumed as the controller 30. Instead of this, the functionality of the controller 30 can be virtualized to be implemented as a cloud service.

(5) In addition, the configurations of the controller, the sensor, and the base station, the processing procedures, the processing contents, and the radio resource to be used, and the like can be variously modified and implemented without departing from the gist of the present invention.

That is, in a case where the number of each element such as the number, the quantity, the amount, and the range is mentioned in the above embodiments, the technology according to the present disclosure is not limited to the mentioned number unless otherwise specified or clearly specified in principle. In addition, the structures, the steps, and the like described in the above embodiments are not necessarily essential to the technology according to the present disclosure, unless otherwise specified or clearly specified in principle.

### REFERENCE SIGNS LIST

1 Wireless terminal

2 Service area

10 Base station

11 Wireless transmission/reception unit

12 Signal demodulation unit

13 Parameter setting unit

13a Transmission power control unit

14 Measurement signal generation unit

20 Sensor

21 Wireless transmission/reception unit

22 Reception quality measurement unit

23 Signal demodulation unit

24 Feedback signal generation unit

30 Controller

31 Communication unit

32 Processor

32a Parameter set determination unit

33 Memory

33a Program

40 Feedback signal

50 Feedback signal

60 Parameter set

70 Measurement signal

80 Network

1. A local wireless communication system for forming a wireless communication environment on a predetermined band, the local wireless communication system comprising:
a base station configured to emit a radio wave to form the wireless communication environment in an area predetermined;
a plurality of sensors disposed in the area; and
a controller configured to control a transmission state of the radio wave of the base station,
the plurality of sensors each being configured to perform:
processing of receiving a measurement signal transmitted from the base station;
processing of measuring a reception quality of the measurement signal received; and
processing of feeding back the reception quality to the controller either via the base station or in a direct manner,
the controller being configured to perform:
processing of evaluating the reception quality fed back from each of the plurality of sensors to determine a parameter to be given to the base station in accordance with an evaluation result; and
processing of giving the parameter determined to the base station, and
the base station being configured to perform:
processing of generating a measurement signal; and
processing of transmitting the measurement signal in accordance with the parameter given from the controller.

2. The local wireless communication system according to claim 1, wherein
in the processing of determining the parameter, the controller changes the parameter in a case where the lowest value of index values of a plurality of the reception qualities measured by the corresponding plurality of sensors is lower than the lowest target value.

3. The local wireless communication system according to claim 1, wherein
in the processing of determining the parameter, the controller changes the parameter in a case where a total value of the index values of the plurality of the reception qualities measured by the corresponding plurality of sensors is lower than a target total value.

4. The local wireless communication system according to claim 1, further comprising
a plurality of area edge sensors disposed along an edge of the area,
the plurality of area edge sensors each being configured to perform:
processing of receiving the measurement signal transmitted from the base station;
processing of measuring reception power of the measurement signal received; and
processing of feeding back the reception power to the controller either via the base station or in a direct manner, wherein
in the processing of determining the parameter, the controller determines the parameter on condition that the reception power fed back from each of the plurality of area edge sensors is equal to or smaller than a threshold.

5. The local wireless communication system according to claim 1, wherein
the plurality of sensors are a plurality of wireless terminals capable of transmitting and receiving a signal to and from the base station,
in the processing of transmitting the measurement signal, the base station transmits an SS/PBCH block with a different parameter by using a standardly specified resource as an SS/PBCH block having a pseudo-different beam,
each of the plurality of wireless terminals
receives, in the processing of receiving the measurement signal, the SS/PBCH block with the different parameter,
measures, in the processing of measuring the reception quality, the reception quality of the SS/PBCH block with the different parameter as an SS/PBCH block subject to beam sweeping according to a standard, and
operates, in the processing of feeding back the reception quality, an initial access to the base station by using an SS/PBCH block having the reception quality that is best, and
the controller determines, as the processing of determining the parameter to be given to the base station, a parameter corresponding to the SS/PBCH block used for the initial access operation by the wireless terminal as the parameter to be given to the base station.

6. An in-area reception quality control method for controlling a reception quality in an area predetermined in which a wireless communication environment is formed with a radio wave on a predetermined band emitted from a base station, the in-area reception quality control method comprising:
receiving, by a plurality of sensors disposed in the area, a measurement signal transmitted from the base station;
measuring the reception quality of the measurement signal received by each of the plurality of sensors; and
evaluating the reception quality measured to control a parameter of the base station in accordance with an evaluation result.

7. A controller applicable to a local wireless communication system including a base station that emits a radio wave on a predetermined band to form a wireless communication environment in a predetermined area and a plurality of sensors disposed in the area, the controller comprising:
a memory configured to store a program; and
a processor configured to execute the program, wherein
the processor executes processing of evaluating a reception quality of a measurement signal from the base station received by each of the plurality of sensors in accordance with the program and controlling a parameter of the base station in accordance with an evaluation result.

8. (canceled)
